(19) United States
(12) Patent Application Publication
(10) Pub. No.: US 2011/0219331 A1
(43) Pub. Date: Sep. 8, 2011

(54) WINDOW RESIZE ON REMOTE DESKTOPS

(75) Inventors: Lisa Seacat DeLuca, San Francisco, CA (US); Steven M. Miller, Cary, NC (US)

(73) Assignee: INTERNATIONAL BUSINESS MACHINES CORPORATION, Armonk, NY (US)

(21) Appl. No.: 12/715,909

(22) Filed: Mar. 2, 2010

(51) Int. Cl. G06F 3/048

(52) U.S. Cl. 715/799; 715/800; 715/810

(57) ABSTRACT

Methods, apparatus, and articles for fitting a graphical user interface screen within a remote desktop screen. A predefined event may resize one of a graphical user interface screen within a remote desktop screen or the remote desktop screen itself such that the graphical user interface screen is fully visible within the remote desktop screen.

### BACKGROUND

1. Field

The present invention generally relates to remote desktop software, and more specifically to resizing windows on a remote desktop.

2. Description of the Related Art

Remote desktop applications are widely used today to allow a user to access a remote computer via the user's local computer. The remote desktop applications simulate the user's presence in front of the remote computer by allowing input and output devices of the user's local computer to be used to interact with the remote computer. For example, a portion of the remote computer screen may be displayed on a monitor of the user's local computer. The user may use input devices of the local computer such as a mouse, keyboard, or the like, to interact with the portion of the remote computer screen that is displayed locally.

### SUMMARY

The present invention generally relates to remote desktop software, and more specifically to resizing windows on a remote desktop.

One embodiment of the invention provides a method for displaying a graphical user interface within a remote desktop screen. The method generally comprises generating the graphical user interface having a first size within the remote desktop screen having an arbitrary second size, wherein at least a portion of the graphical user interface is not visible within the remote desktop screen, and receiving a predefined input from a remote desktop device configured to re-render at least one of the graphical user interface and the remote desktop screen. The method further comprises automatically resizing at least one of the graphical user interface and the remote desktop screen in response to receiving the predefined input such that the entire graphical user interface is visible within the remote desktop screen.

Another embodiment of the invention provides a computer readable storage medium comprising a program product which, when executed is configured to perform an operation for displaying a graphical user interface within a remote desktop screen. The operation generally comprises generating the graphical user interface having a first size within the remote desktop screen having an arbitrary second size, wherein at least a portion of the graphical user interface is not visible within the remote desktop screen, and receiving a predefined input from a remote desktop device configured to re-render at least one of the graphical user interface and the remote desktop screen. The operation further comprises automatically resizing at least one of the graphical user interface and the remote desktop screen in response to receiving the predefined input such that the entire graphical user interface is visible within the remote desktop screen.

Yet another embodiment of the invention provides a system comprising a remote client device comprising a remote desktop application configured to generate a graphical user interface having a first size within a remote desktop screen having an arbitrary second size, wherein at least a portion of the graphical user interface is not visible within the remote desktop screen. The system further comprises a host computing device configured to receive a predefined input from the remote computing device, and in response to receiving the predefined input, automatically resize at least one of the graphical user interface and the remote desktop screen such that the entire graphical user interface is visible within the remote desktop screen.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates an exemplary desktop view according to an embodiment of the invention.

FIGS. 3A-B illustrate resizing a graphical user interface screen to fit within a remote desktop screen, according to an embodiment of the invention.

FIGS. 4A-B illustrate resizing of a remote desktop screen to fully encompass a graphical user interface, according to an embodiment of the invention.

FIG. 5 is a flow diagram of exemplary operations performed to resize graphical user interfaces, according to an embodiment of the invention.

### DETAILED DESCRIPTION OF THE PREFERRED EMBODIMENTS

Embodiments of the invention provide methods, apparatus, and articles for fitting a graphical user interface screen within a remote desktop screen. A predefined event may resize one of a graphical user interface screen within a remote desktop screen or the remote desktop screen itself such that the graphical user interface screen is fully visible within the remote desktop screen.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

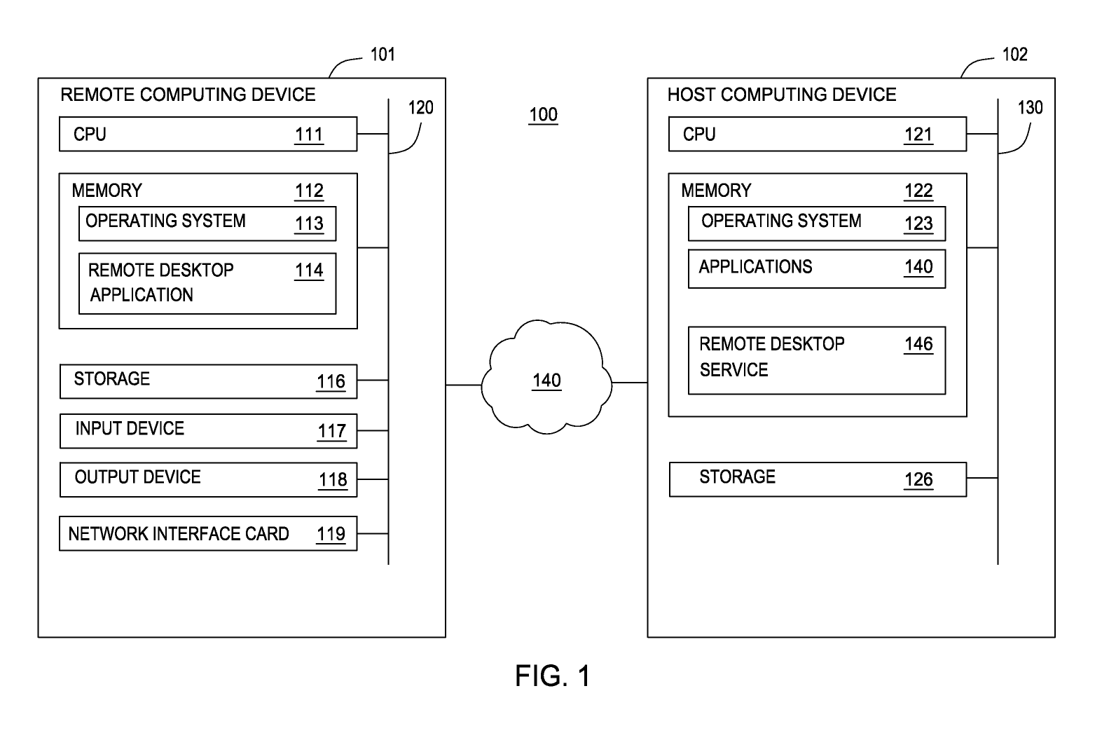

FIG. 1 depicts a block diagram of a networked system 100 in which embodiments of the invention may be implemented. In general, the networked system 100 includes a remote computing device 101 and a host computing device 102. The remote computing device 101 and host computing device 102 are connected via a network 140. In general, the network 140 may be a local area network (LAN) and/or a wide area network (WAN). In a particular embodiment, the network 140 is the Internet.

The remote computing device 101 and the host computing device 102 may be any type of devices including, for example, personal digital assistants (PDAs), handheld devices, laptop computers, desktop computers, mainframes, appliances, or the like. In a particular embodiment, the host computing device may be a server configured to provide remote access to one or more remote computing devices 101.

As illustrated in FIG. 1, the remote computing device 101 includes a Central Processing Unit (CPU) 111 connected via a bus 120 to a memory 112, storage 116, an input device 117, an output device 118, and a network interface device 119. The input device 117 can be any device to give input to the remote computing device 101. For example, a keyboard, keypad, light-pen, touch-screen, track-ball, or speech recognition unit, audio/video player, and the like could be used.

The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the remote computing device 101 and host computing device 102 via the network 140. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 112 is also shown containing a remote desktop application 114 which, when executed by CPU 111, provides support for interacting with one or more applications at the host computing device 102, as will be discussed in greater detail below. In one embodiment, the remote desktop application 114 may include a Graphical User Interface (GUI), which allows the user to display interfaces for interacting with the applications (e.g., the applications 140) at the host computing device 102. The GUI may be configured to receive inputs from the input device 117 to facilitate interaction between the user and the applications at the host computing device 102.

The host computing device 102 may by physically arranged in a manner similar to the remote computing device 101. Accordingly, the host computing device 102 is shown generally comprising at least one CPU 121, memory 122, and a storage device 126, coupled with one another by a bus 130. Memory 122 may be a random access memory sufficiently large to hold the necessary programming and data structures that are located on host computing device 102.

The host computing device 102 may generally be under the control of an operating system 123 shown residing in memory 122. Examples of the operating system 123 include IBM OS/4000, UNIX, Microsoft Windows®, and the like. More generally, any operating system capable of supporting the functions described herein may be used.

The memory 122 further includes one or more applications 140 and a remote desktop service 146. The applications 140 and the remote desktop service 146 are software products comprising a plurality of instructions that are resident at various times in various memory and storage devices in the computer system 100. When read and executed by one or more processors 121 in the host computing device 102, the applications 140 and the remote desktop service 146 cause the computer system 100 to perform the steps necessary to execute steps or elements embodying the various aspects of the invention.

In one embodiment of the invention, the remote desktop service 146 may be configured to receive user inputs that are transferred from a remote computing device 101. For example, a user may provide input to the remote computing device 101 using the input device 117. In one embodiment, the remote desktop application 114 may be configured to transfer the user input to the host computing device 102 via the network 140. The user input may be received by the remote desktop service 146 which may cause the one or more of the applications 140 to perform one or more operations desired by the user. In one embodiment, information regarding one or more operations performed by the applications 140 may be transferred to the remote computing device 101 by the remote desktop service 146. The transferred information may be received by the remote desktop application 114, which may modify the GUI providing interfaces for interacting with the applications 140 at the host computing device 102.

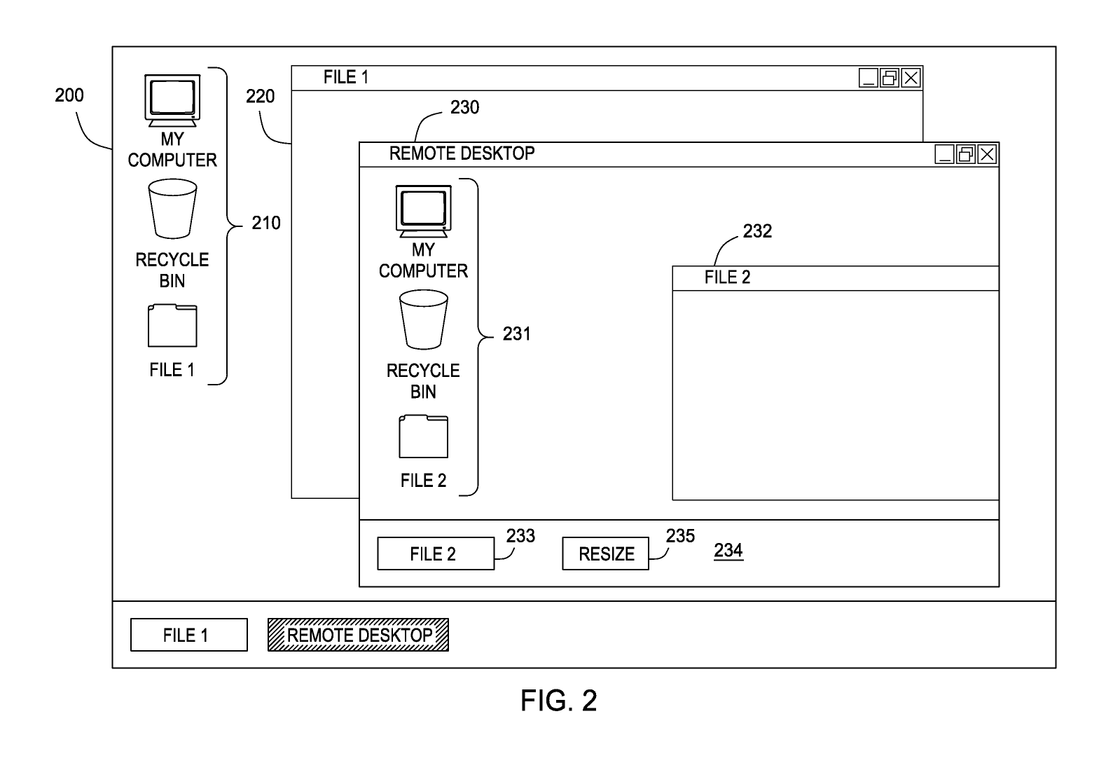

FIG. 2 illustrates a desktop view 200 that may be generated by the remote computing device 101, according to an embodiment of the invention. The desktop view may be displayed at an output device 118, e.g., a computer monitor screen. As illustrated in FIG. 2, the desktop view 200 illustrates one or more icons 210. The icons 210 may be associated with one or more applications or files that are available locally to the remote computing device 101. For example, a My Computer icon, a recycle bin icon, and a file 1 icon are shown in FIG. 2.

The desktop view 200 also illustrates a plurality of graphical user interface (GUI) screens, e.g., the screens 220 and 230. In one embodiment of the invention, the GUI screens 220 and 230 may be windows configure to provide an interface between a user of the remote computing device 101 and an application. For example, the GUI screen 220 is associated with a document titled file 1, which may be associated with a local application at the remote computing device.

In one embodiment of the invention, the GUI screen 230 may be generated by the remote desktop application 114. Accordingly, the GUI screen 230 may be configured to display at least a portion of a desktop view generated by the host computing device 102. For example, the GUI screen 230 shows a plurality of icons 231 (My Computer, recycle bin, and file 2) which may be associated with applications and/or files that are local to the host computing device 102. In one embodiment, the GUI screen 230 may have an arbitrary size. In a particular embodiment, the GUI screen may not be maximized, as illustrated in FIG. 2.

FIG. 2 further illustrates a GUI screen 232 within the remote desktop GUI 230. The GUI 232 may provide an interface for interacting with one or more applications and/or files that are local to the host computing device 102. For example, a document file 2 is shown in the GUI 232 of FIG. 1. FIG. 1 also illustrates buttons 241 and 242 in a task bar area 240 of the desktop 200. The button 241 may be associated with the GUI screen 220, and the button 242 may be associated with the remote desktop GUI 230.

In one embodiment, clicking the buttons 241 or 242 may cause a respective GUI 220 or 230 to become active on the desktop. For example, clicking the button 241 may cause GUI 220 to become active. In one embodiment, an activated GUI may be brought to the foreground if it is overlapped by one or more other GUIs. For example, in FIG. 2, the GUI 220 is overlapped by the GUI 230. Therefore, clicking the button 241 may cause the GUI 220 to be brought to the foreground, thereby making all the contents within the area of the GUI 230 visible to the user.

In one embodiment, the buttons in the task bar area 240 may indicate which of a plurality of GUIs is currently active in the desktop view 200. For example, in FIG. 2, the button 241 associated with the remote desktop GUI 230 is shaded, thereby indicating that the remote desktop GUI 230 is currently active. While shading the buttons in the task bar area is disclosed herein, in alternative embodiments, any reasonable method for indicating an active GUI may be used. For example, in some embodiments, the button text may be bold faced and/or italicized. In another embodiment, thicker borders may be used to indicate an active GUI screen.

FIG. 1 also illustrates a button 233 within a task bar area 234 of the remote desktop GUI 230 which may operate in the same way as the buttons illustrated in the task bar area 240. In one embodiment, clicking buttons in the task bar area 234 may cause the remote desktop application 114 to send data regarding the user input to the remote desktop service 146 in the host computing device 102. The remote desktop service 146 may respond to the user input by sending an appropriate response to the remote desktop application 114, thereby causing it to activate a GUI (within the remote desktop GUI 230) associated with the clicked button in the task bar area 234.

As illustrated in FIG. 2, only a portion of the GUI 232 is shown within the remote desktop GUI 230. In order to view greater portions of the GUI 232, a user may typically move the GUI 232 towards the upper left corner of the remote desktop GUI 230. The user may also have to drag one or more edges of the GUI 232 to resize the GUI 232 within the remote desktop GUI 230. The steps for resizing the GUI 232 within the remote desktop 230 may be consume a lot of time, which may be undesirable. Furthermore, users that may desire to resize a large number of GUIs within the remote desktop GUI 230 may find it especially cumbersome to individually select, drag and resize each GUI.

Embodiments of the invention may provide a fast and efficient method for automatically resizing a GUI within a remote desktop GUI. For example, in one embodiment, the remote desktop application 114 may be configured to detect a predefined input from an input device 117 of the remote computing device 101. In response to detecting the predefined input, the remote desktop application 114 may send a notification to the remote desktop service 146 of the host computing device indicating that a resizing of a GUI is desired within the remote desktop GUI. The remote desktop service may respond to the notification, thereby causing the remote desktop application to modify the GUI within the remote desktop GUI such that the user is provided a desirable view.

Any reasonable type of predefined input may be used by a user to indicate a desire to resize the GUI within the remote desktop GUI. Examples of predefined inputs may include for example, right clicking a mouse, clicking a predefined one or more keys on a keyboard, and the like. In one embodiment, the remote desktop application 114 may be configured to detect the predefined input only when the remote desktop GUI 230 is active in the desktop view 200. In other words, when the remote desktop GUI 230 is not active, providing the predefined input may not cause a GUI within the remote desktop GUI 230 to be resized.

In one embodiment, one or more graphical tools may be provided within the remote desktop GUI 230 for providing input for resizing a GUI therein. For example, a resize button 235 may be provided in the task bar area 234. Clicking the resize button may cause an active GUI within the remote desktop GUI 230 to be resized. While a button 235 is shown in FIG. 1, in alternative embodiments, any reasonable graphical tool including, for example, radio buttons, check boxes, drop-down menus, or the like, may be used to request resizing of a GUI within the remote desktop GUI 230.

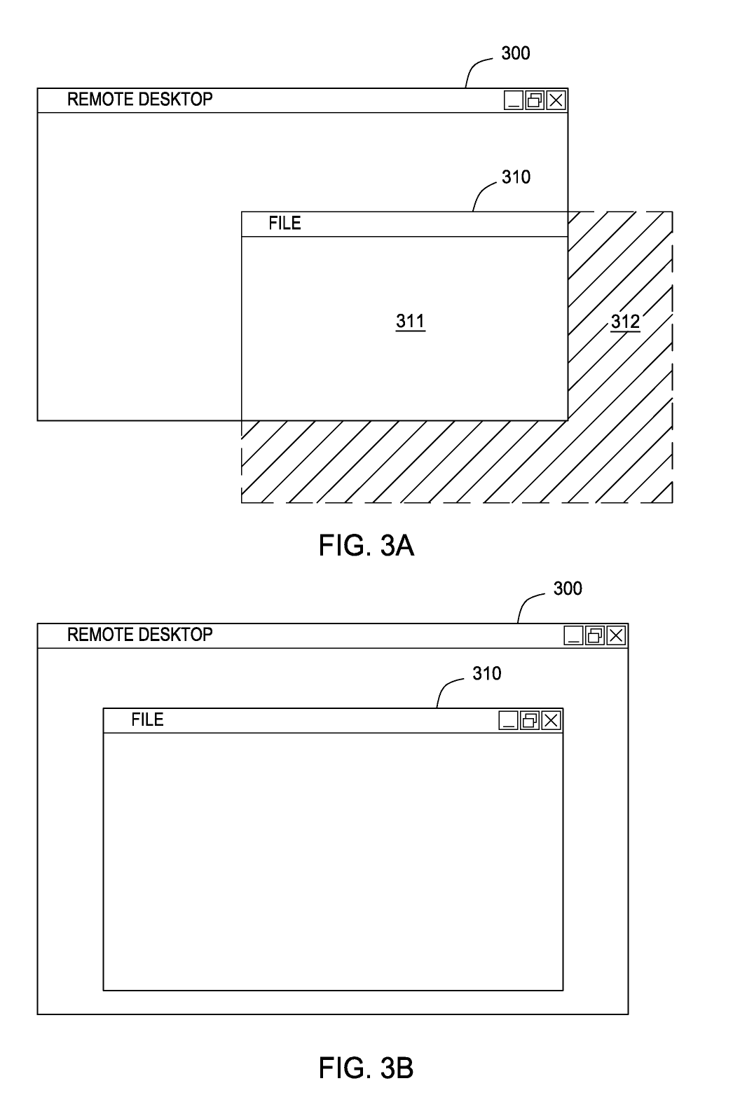

FIG. 3A-B illustrate remote desktop GUI screen 300 before and after a request for resizing a GUI 310 within the remote desktop GUI 300 is sent to the host computing device 102 via a predefined event. As illustrated in FIG. 3A, only a portion 311 of the GUI 310 is visible within the remote desktop GUI 300, whereas a portion 312 is hidden because it is outside the bounds of the remote desktop GUI 300. FIG. 3B illustrates the remote desktop GUI 300 after a predefined event such as, for example, clicking the resize button 235 illustrated in FIG. 2. As illustrated in FIG. 3B, the GUI 310 has been moved and/or resized such that the entire GUI 310 is visible within the display area of the remote desktop GUI 300. Particularly, the GUI 310 has been moved to align with the top left corner of the remote desktop GUI 300. While not shown in FIG. 3B, in some embodiments, the size of the GUI 310 may also be adjusted to fit within the remote desktop GUI 300.

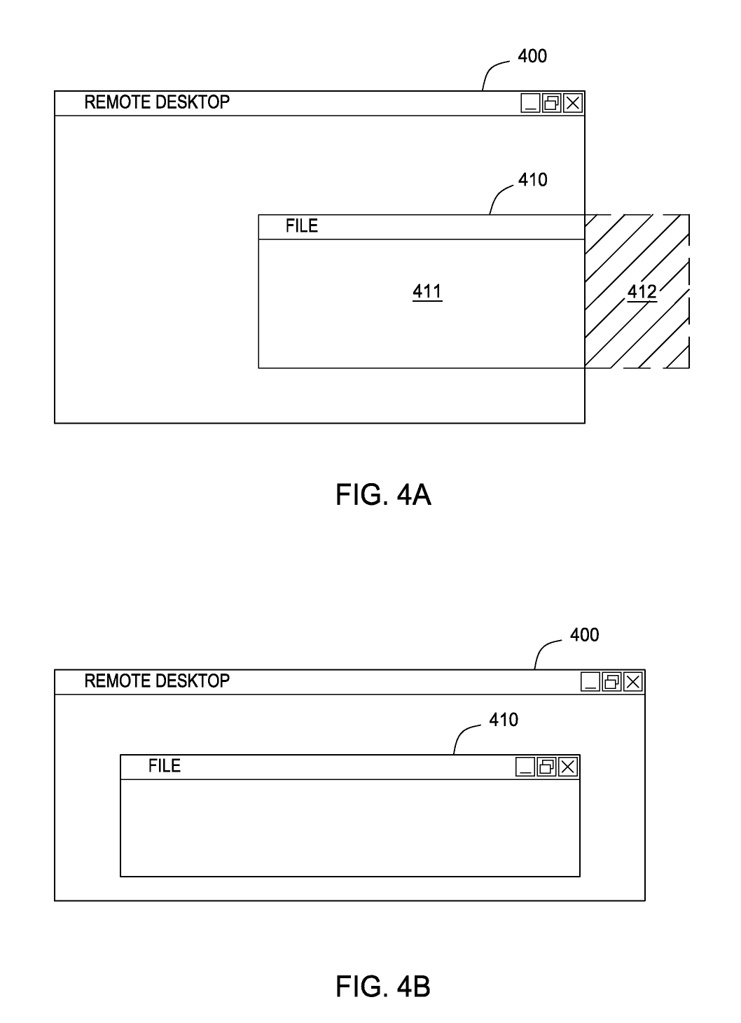

In one embodiment of the invention, the remote desktop GUI may itself be resized to fit around a GUI therein. FIG. 4A-B illustrate an exemplary remote desktop GUI 400 before and after a request for resizing is sent to the host computing device 102. As illustrated in FIG. 4A, only a portion 411 of a GUI 410 is visible within the remote desktop GUI 400, whereas a portion 412 is hidden because it is outside the bounds of the remote desktop GUI 400. As illustrated in FIG. 4B, the remote desktop GUI 400 has been resized to fit around the GUI 410 such that the entire GUI 410 as originally shown in FIG. 4A is shown within the remote desktop GUI 400.

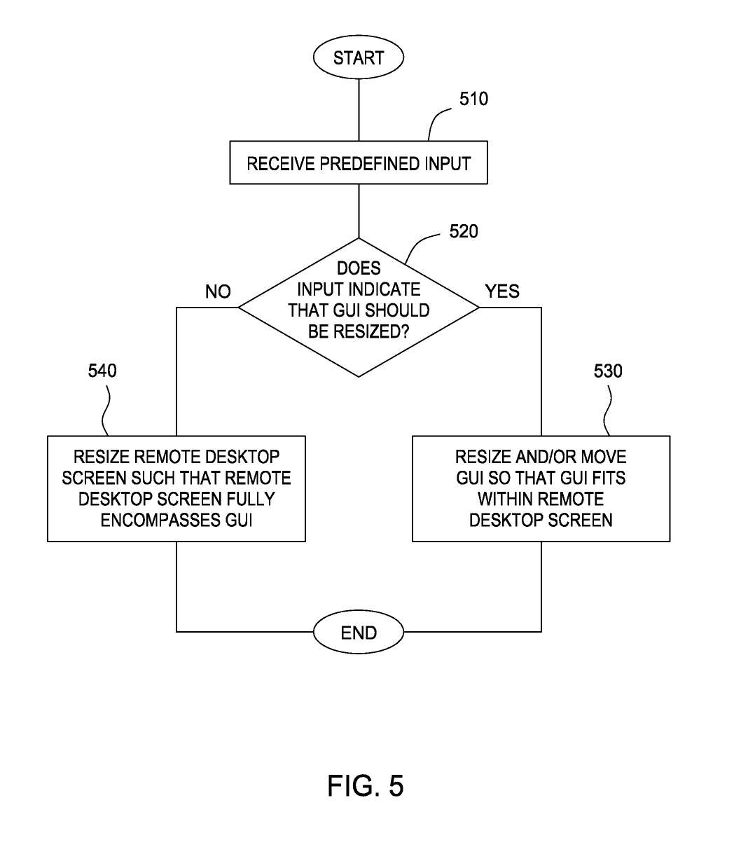

FIG. 5 illustrates an exemplary flow diagram of exemplary operations performed to fit a graphical user interface screen within a remote desktop screen, according to an embodiment of the invention. The operations may begin in step 510 by receiving a predefined input, for example, one or more mouse clicks, selection of a graphical tool, one or more keyboard presses, or the like. In one embodiment, the predefined user input may be received by a host computing device 102. For example, in one embodiment, the user input may be received at a remote computing device 101. A remote desktop application 114 of the remote computing device may transfer the user input to the host computing device 102 via a network 140.

In step 520, a remote desktop service 146 at the remote computing device may determine whether the predefined input indicates that the graphical user interface screen should be resized. If yes, then in step 530, the remote desktop service 146 may move and/or resize the graphical user interface screen so that the graphical user interface screen fits within the remote desktop screen.

However, if the predefined input indicates that the graphical user interface screen should not be resized, then in step 540, the remote desktop service 146 may resize the remote desktop screen so that the remote desktop screen fully encompasses the graphical user interface screen.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for displaying a graphical user interface within a remote desktop screen, comprising:
generating the graphical user interface having a first size within the remote desktop screen having a second size, wherein a portion of the graphical user interface is not visible within the remote desktop screen;
receiving an input from a remote desktop device configured to re-render one of the graphical user interface and the remote desktop screen; and
in response to receiving the input, resizing one of the graphical user interface and the remote desktop screen such that the entire graphical user interface is visible within the remote desktop screen.

2. The method of claim 1, wherein the input indicates that resizing of the graphical user interface is desired, and wherein the resizing comprises:
adjusting the graphical user interface from the first size to a third size; and
moving the graphical user interface from a first position to a second position, wherein the adjustment in size and the movement of the graphical user interface places the entire graphical user interface within the remote desktop screen.

3. The method of claim 1, wherein the input indicates that resizing of the remote desktop screen is desired, and wherein the resizing comprises adjusting the remote desktop screen from the second size to a fourth size, wherein the adjustment results in the remote desktop screen fully encompassing the graphical user interface.

4. The method of claim 1, wherein the input comprises at least one mouse click.

5. The method of claim 1, wherein the input comprises a keyboard event comprising pressing of at least one key.

6. The method of claim 1, wherein the input comprises receiving an input via a graphical tool.

7. The method of claim 6, wherein the graphical tools comprise:
a button;
a radio button;
a checkbox; and
a drop down menu.

8. A computer readable storage medium comprising a program product which, when executed is configured to perform an operation for displaying a graphical user interface within a remote desktop screen, comprising:
generating the graphical user interface having a first size within the remote desktop screen having a second size, wherein a portion of the graphical user interface is not visible within the remote desktop screen;
receiving an input from a remote desktop device configured to re-render one of the graphical user interface and the remote desktop screen; and
in response to receiving the input, resizing one of the graphical user interface and the remote desktop screen such that the entire graphical user interface is visible within the remote desktop screen.

9. The computer readable storage medium of claim 8, wherein the input indicates that resizing of the graphical user interface is desired, and wherein the resizing comprises:
adjusting the graphical user interface from the first size to a third size; and
moving the graphical user interface from a first position to a second position, wherein the adjustment in size and the movement of the graphical user interface places the entire graphical user interface within the remote desktop screen.

10. The computer readable storage medium of claim 8, wherein the input indicates that resizing of the remote desktop screen is desired, and wherein the resizing comprises adjusting the remote desktop screen from the second size to a fourth size, wherein the adjustment results in the remote desktop screen fully encompassing the graphical user interface.

11. The computer readable storage medium of claim 8, wherein the input comprises at least one mouse click.

12. The computer readable storage medium of claim 8, wherein the input comprises a keyboard event comprising pressing of at least one key.

13. The computer readable storage medium of claim 8, wherein the input comprises receiving an input via a graphical tool.

14. The computer readable storage medium of claim 13, wherein the graphical tools comprise:
a button;
a radio button;
a checkbox; and
a drop down menu.

15. A system, comprising:
a remote client device comprising a remote desktop application configured to generate a graphical user interface having a first size within a remote desktop screen having a second size, wherein a portion of the graphical user interface is not visible within the remote desktop screen; and
a host computing device configured to:
receive an input from the remote computing device; and
in response to receiving the input, resize one of the graphical user interface and the remote desktop screen such that the entire graphical user interface is visible within the remote desktop screen.

16. The system of claim 15, wherein the input indicates that resizing of the graphical user interface is desired, and wherein the host computing device is further configured to:
adjust the graphical user interface from the first size to a third size; and
move the graphical user interface from a first position to a second position, wherein the adjustment in size and the movement of the graphical user interface places the entire graphical user interface within the remote desktop screen.

17. The system of claim 15, wherein the input indicates that resizing of the remote desktop screen is desired, and wherein the host computing device is further configured to adjust the remote desktop screen from the second size to a fourth size, wherein the adjustment results in the remote desktop screen fully encompassing the graphical user interface.

18. The system of claim 15, wherein the input comprises at least one mouse click.

19. The system of claim 15, wherein the input comprises a keyboard event comprising pressing of at least one key.

20. The system of claim 15, wherein the input comprises receiving an input via a graphical tool.
